(19) United States
(12) Patent Application Publication
(10) Pub. No.: US 2009/0205521 A1
(43) Pub. Date: Aug. 20, 2009

(54) Method and Apparatus for Coupling and Uncoupling a Plate Cylinder in a Sheetfed Printing Press and Sheetfed Rotary Printing Press Having the Apparatus

(75) Inventors: Christian Gorbing, Heidelberg (DE); Martin Greive, Schriesheim (DE); Jens Hieronymus, Darmstadt (DE); Carsten Kelm, Ketsch (DE); Alexander Knabe, Heidelberg (DE); Rolf Kundgen, Bad Schonborn (DE); Michael Postels, Dossenheim (DE); Stephan Rudzewitz, Walldorf (DE); Dirk Schonmann, Schifferstadt (DE); Markus Stark, Zuzenhausen (DE); Jan Teubert, Heidelberg (DE); Mathias Zuber, Helmstadt-Bargen (DE)

Correspondence Address: LERNER GREENBERG STEMER LLP, P O BOX 2480, HOLLYWOOD, FL, 33022-2480, US

(73) Assignee: HEIDELBERGER DRUCKMASCHINEN AG, Heidelberg (DE)

(21) Appl. No.: 12/388,155

(22) Filed: Feb. 18, 2009

(30) Foreign Application Priority Data
Feb. 18, 2008 (DE) 10 2008 009 618.0

(51) Int. Cl. B41F 5/00

(52) U.S. Cl. 101/216

(57) ABSTRACT

A method and an apparatus for coupling or uncoupling a cylinder, in particular a plate or blanket cylinder, to or from a gear train of a printing press or for coupling and uncoupling the cylinder to and from an auxiliary drive, for example for service work or during changeover processes, includes firstly accelerating the auxiliary drive to a predefined rotational speed, then coupling the auxiliary drive to the cylinder and then uncoupling the cylinder from the main drive. A sheetfed rotary printing press having the apparatus is also provided.

### CROSS-REFERENCE TO RELATED APPLICATION

This application claims the priority, under 35 U.S.C. § 119, of German Patent Application DE 10 2008 009 618.0, filed Feb. 18, 2008; the prior application is herewith incorporated by reference in its entirety.

### BACKGROUND OF THE INVENTION

### Field of the Invention

The invention relates to a method and an apparatus for coupling and uncoupling a plate cylinder in a main drive gear train of a sheetfed printing press and to coupling and uncoupling the plate cylinder to and from an auxiliary motor. The invention also relates to a sheetfed rotary printing press having the apparatus.

A method of that type and a coupling specified to carry out the method are known, for example, from German Published, Non-Prosecuted Patent Application DE 10 2005 018 677 A1. That publication shows a plate cylinder of a sheetfed printing press which is connected to a gear train of the sheetfed printing press through the use of a self-locking form-locking control coupling. When the machine is at a standstill, the plate cylinder can be uncoupled from the main drive gear train and is disposed in such a way that it can be driven through the use of an auxiliary drive. A form-locking connection is one which connects two elements together due to the shape of the elements themselves, as opposed to a force-locking connection, which locks the elements together by force external to the elements.

### SUMMARY OF THE INVENTION

It is accordingly an object of the invention to provide a method and an apparatus for coupling and uncoupling a plate cylinder in a sheetfed printing press during rotation of the cylinder and a sheetfed rotary printing press having the apparatus, which overcome the hereinafore-mentioned disadvantages of the heretofore-known methods and devices of this general type.

With the foregoing and other objects in view there is provided, in accordance with the invention, a method for optionally driving a cylinder of a printing press through a gear train connected to a main drive of the printing press or through an auxiliary drive. The method comprises providing a controllable coupling between the gear train and the cylinder, and driving the cylinder through the auxiliary drive by firstly accelerating the auxiliary drive to a predefined rotational speed, then coupling the auxiliary drive to the cylinder, and then uncoupling the cylinder from the gear train.

With the objects of the invention in view, there is also provided a method for optionally driving a cylinder of a sheetfed printing press through a gear train connected to a main drive of the printing press or through an auxiliary drive. The method comprises providing a controllable coupling between the gear train and the cylinder, and driving the cylinder through the gear train by coupling the cylinder to the gear train at a predefined rotational speed, and then uncoupling the auxiliary drive.

With the objects of the invention in view, there is concomitantly provided an apparatus for driving a cylinder of a printing press. The apparatus comprises a gear train connected to a main drive of the printing press, an auxiliary drive, and

a controllable first coupling between the gear train and the cylinder and a controllable second coupling between the auxiliary drive and the cylinder, for carrying out one of the methods according to the invention described above.

It is a particular advantage of the method of the invention that the plate cylinder can be uncoupled from the gear train during its rotation and coupled to an auxiliary drive or can be uncoupled from the auxiliary drive and coupled to the main drive. As a result of this measure, the changeover time, for example changing the printing plate or washing work as well as further service work, of the plate cylinder can be shortened.

In a particularly advantageous way, in terms of apparatus, the invention is provided with a force-locking coupling between the gear train and the plate cylinder. Preferably, a second force-locking coupling is also provided between the plate cylinder and the auxiliary drive.

Other features which are considered as characteristic for the invention are set forth in the appended claims.

Although the invention is illustrated and described herein as embodied in a method and an apparatus for coupling and uncoupling a plate cylinder in a sheetfed printing press and a sheetfed rotary printing press having the apparatus, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, longitudinal-sectional view of a sheetfed rotary printing press;

FIG. 2 is an enlarged, schematic and block diagram of a coupling configuration for a plate cylinder; and

FIG. 3 is a further enlarged, fragmentary, cross-sectional view of a force-locking coupling with a fixed-point coupling.

### DETAILED DESCRIPTION OF THE INVENTION

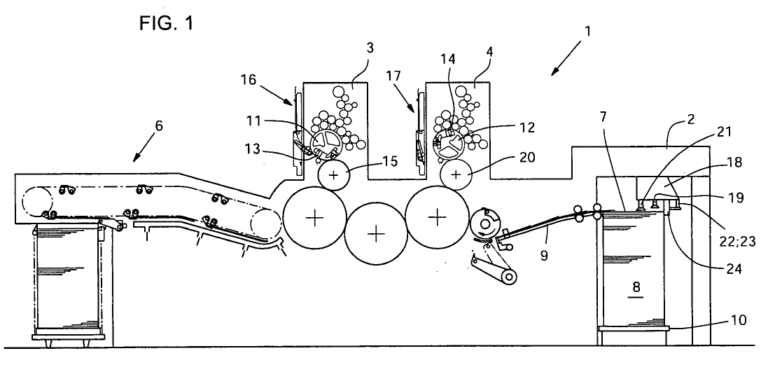

Referring now to the figures of the drawings in detail and first, particularly, to FIG. 1 thereof, there is seen a machine, for example a printing press 1, for processing sheets 7. The printing press 1 has a feeder 2, at least one printing unit 3 and 4 and a delivery 6. The sheets 7 are removed from a sheet stack 8 and are fed, separated or in overlapping formation, over a feed table 9 to the printing units 3 and 4. The printing units 3 and 4 each contain a respective plate cylinder 11, 12 and blanket cylinder 15, 20 interacting therewith, in a known way. The plate cylinders 11 and 12 each have a clamping device 13, 14 for fixing flexible printing plates. Furthermore, each plate cylinder 11, 12 is assigned an apparatus 16, 17 for semiautomatic or fully automatic printing plate changing.

The sheet stack 8 rests on a stack board 10 which can be raised under control. The sheets 7 are removed from the top side of the sheet stack 8 through the use of a so-called suction head 18 which, inter alia, has a number of lifting and dragging suckers 19, 21 to separate the sheets 7. Furthermore, blowing devices 22 are provided to loosen the upper sheet layers, and sensing elements 23 are provided for stack tracking. A number of side and rear stops 24 are provided in order to align the sheet stack 8, in particular the upper sheets 7 of the sheet stack 8.

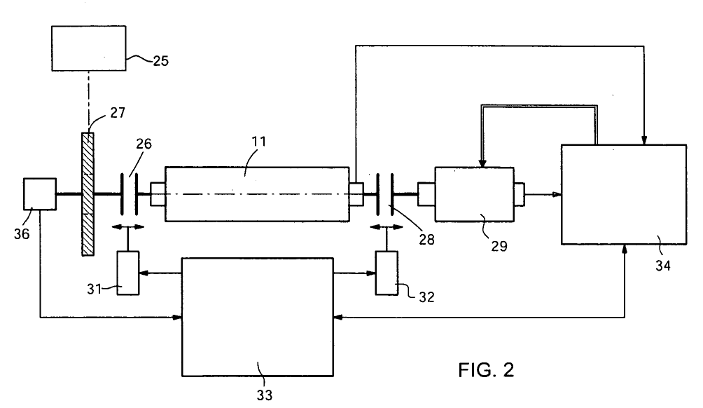

As is seen in FIG. 2, a plate cylinder 11, 12 or a blanket cylinder 15, 20 is connected in drive terms to a gear train 27 connected to a main drive 25 of the sheet processing machine 1 through the use of a controllable force-locking fixed point coupling 26. A further controllable force-locking coupling 28 connects the plate or blanket cylinder 11, 12 or 15, 20 in drive terms to an auxiliary drive 29. An actuating device 31 for the first coupling 26 as well as an actuating device 32 for the second coupling 28 are connected to a machine control system 33. A drive control system 34 for the auxiliary drive 29 as well as a rotary speed transmitter 36 disposed on the gear train 27 are likewise connected to the machine control system 33. In the following text, the invention will be described only with regard to the configuration of the plate cylinder 11.

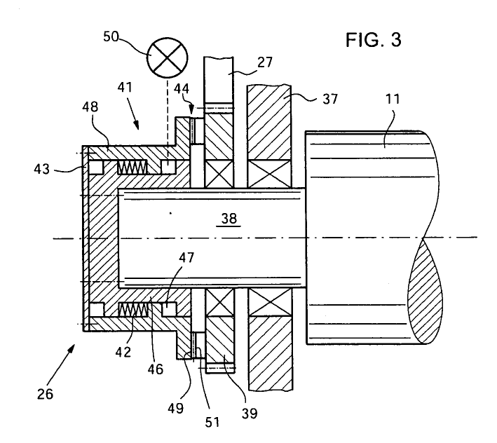

FIG. 3 shows the coupling 26 which, for example, can be actuated pneumatically, and is disposed on a bearing journal 38 of the plate cylinder 11 mounted in a side frame 37 of the printing press 1. A gear 39 of the plate cylinder 11, which is mounted on the journal 38 so that it can rotate freely, meshes with the gear train 27 of the printing press 1.

The coupling 26 substantially includes an actuating element 41 that can be actuated pneumatically and a compression spring 42, a diaphragm 43 for transmitting rotational force and an axial clutch 44.

The actuating element 41 embraces the end of the bearing journal 38 coaxially and includes an inner part 46 firmly connected to the bearing journal 38 and an outer part 48 which forms an annular working chamber 47 with the inner part 46. The working chamber 47 can be pressurized with compressed air from a pressure source 50 through a non-illustrated rotary leadthrough. The inner part 46 and the outer part 48 are connected rotationally to each other through the use of the diaphragm 43. However, the diaphragm 43 permits axial displacement of the outer part 48 with respect to the inner part 46.

The compression spring 42, preferably a number of compression springs 42 distributed about the circumference of the bearing journal 38, presses the outer part 48 onto the plate cylinder 11 in the axial direction. The outer part 48 has an axial toothing system 49, which is disposed in such a way that it can be moved into a controlled connection with an axial toothing system 51 of the gear 39 by the force of the compression spring 42.

The axial clutch 44, having the axial toothing systems 49, 51, is a fixed point coupling, in which the teeth have different thicknesses or tooth modules, so that they can be coupled only in one angular position. In order to avoid self-locking, the teeth have a flank angle of about 5° to 15°, that is to say that the force of the compression spring or springs 42 is configured to be so high that transmission of force is produced by friction.

In order to release the axial clutch 44, the working chamber 47 is pressurized with compressed air and displaces the outer part 48 axially counter to the force of the compression spring 42. The axial toothing systems 49, 51 are separated.

For the purpose of coupling, the working chamber 47 is de-pressurized at an arbitrary angular position of the plate cylinder 11 and the compression spring 42 displaces the outer part 48 to such an extent that the axial toothing systems 49, 51 meet each other. However, coupling at an exact angle takes place only when the modules of the axial toothing systems 49 coincide with the modules of the axial toothing systems 51.

In order to accelerate the coupling and uncoupling of the plate cylinder to and from the main drive gear train 27 or the auxiliary drive 29, the procedure is as follows:

During a drive connection of the plate cylinder 11 to the gear train 27, the auxiliary drive 29 is firstly accelerated to a rotational speed predefined by the machine control system 33, which is synchronized with a rotational speed of the main gear train 27. The coupling 28 is then switched, so that both drives, namely the main drive gear train 27 and the auxiliary drive 29, are coupled to the plate cylinder 11.

In the next step, the coupling 26 is switched pneumatically, so that the plate cylinder 11 is separated from the main gear train 27. The rotational speed of the plate cylinder 11 for all service work is now controlled solely by the auxiliary motor 29.

In order to couple the plate cylinder 11 to the main gear train 27, the pneumatic compressed air is switched off and the compression spring 42 displaces the clutch 44 until coupling of the axial toothing systems 49, 51 in correct phase has been carried out. The auxiliary drive 29 can then be uncoupled by the machine control system 33 at an arbitrary rotational speed, preferably at the rotational speed predefined for coupling.

1. A method for optionally driving a cylinder of a printing press through a gear train connected to a main drive of the printing press or through an auxiliary drive, the method comprising the following steps:
providing a controllable coupling between the gear train and the cylinder; and
driving the cylinder through the auxiliary drive by:
firstly accelerating the auxiliary drive to a predefined rotational speed,
then coupling the auxiliary drive to the cylinder, and
then uncoupling the cylinder from the gear train.

2. A method for optionally driving a cylinder of a sheetfed printing press through a gear train connected to a main drive of the printing press or through an auxiliary drive, the method comprising the following steps:
providing a controllable coupling between the gear train and the cylinder; and
driving the cylinder through the gear train by:
coupling the cylinder to the gear train at a predefined rotational speed, and
then uncoupling the auxiliary drive.

3. An apparatus for driving a cylinder of a printing press, the apparatus comprising:
a gear train connected to a main drive of the printing press;
an auxiliary drive; and
a controllable first coupling between said gear train and the cylinder and a controllable second coupling between said auxiliary drive and the cylinder, for carrying out the method according to claim 1.

4. The apparatus according to claim 3, wherein said first coupling disposed between said gear train and the cylinder is a controllable force-locking coupling.

5. The apparatus according to claim 4, wherein said first coupling has an actuating device with an axial toothing system disposed on a gear and a switching element with an axial toothing system configured to be displaced axially and connected firmly to the cylinder so as to rotate with the cylinder.

6. The apparatus according to claim 5, wherein said first coupling is configured to be actuated pneumatically by a machine control system.

7. The apparatus according to claim 5, wherein said first coupling is a fixed point coupling.

8. The apparatus according to claim 7, wherein said axial toothing systems of said fixed point coupling have a non-locking angle.

9. The apparatus according to claim 8, wherein the angle has a range of from 5° to 15°.

10. The apparatus according to claim 3, wherein the cylinder is a plate cylinder or a blanket cylinder.

11. An apparatus for driving a cylinder of a sheetfed printing press, the apparatus comprising:
a gear train connected to a main drive of the printing press;
an auxiliary drive; and
a controllable first coupling between said gear train and the cylinder and a controllable second coupling between said auxiliary drive and the cylinder, for carrying out the method according to claim 2.

12. The apparatus according to claim 11, wherein said first coupling disposed between said gear train and the cylinder is a controllable force-locking coupling.

13. The apparatus according to claim 12, wherein said first coupling has an actuating device with an axial toothing system disposed on a gear and a switching element with an axial toothing system configured to be displaced axially and connected firmly to the cylinder so as to rotate with the cylinder.

14. The apparatus according to claim 13, wherein said first coupling is configured to be actuated pneumatically by a machine control system.

15. The apparatus according to claim 13, wherein said first coupling is a fixed point coupling.

16. The apparatus according to claim 15, wherein said axial toothing systems of said fixed point coupling have a non-locking angle.

17. The apparatus according to claim 16, wherein the angle has a range of from 5° to 15°.

18. The apparatus according to claim 11, wherein the cylinder is a plate cylinder or a blanket cylinder.

19. A sheetfed rotary printing press, comprising an apparatus according to claim 3.

20. A sheetfed rotary printing press, comprising an apparatus according to claim 11.
